(19) United States
(12) Patent Application Publication
(10) Pub. No.: US 2026/0370573 A1
(43) Pub. Date: Nov. 19, 2026

(54) NF DEVICE, TERMINAL DEVICE, AND SIGNALING CONTROL METHOD PERFORMED BY NF

(71) Applicant: SK TELECOM CO., LTD., Seoul (KR)

(72) Inventors: Dong Jin LEE, Seoul (KR); Hyeon Mo GU, Seoul (KR); Seong Jun LEE, Seoul (KR)

(21) Appl. No.: 19/488,045

(22) PCT Filed: Aug. 7, 2023
(86) PCT No.: PCT/KR2023/011556

§ 371 Date: Nov. 25, 2025

(30) Foreign Application Priority Data
May 30, 2023 (KR) 10-2023-0069026

(51) Int. Cl. H04L 41/34

(52) U.S. Cl. CPC H04L 41/34

(57) ABSTRACT

The present invention presents a method departing from the structural constraint of processing through one interface during communication between NFs so as to implement a specific technical configuration enabling processing through a plurality of interfaces during communication between NFs, and thus can alleviate/solve various problems that can be caused by the conventional structural constraint of processing through one interface during communication between NFs.

### TECHNICAL FIELD

The present disclosure relates to a technology which enables processing through multiple interfaces during communication between network functions (NFs).

This application is based on and claims priority to Korean Patent Application No. 10-2023-0069026, filed on May 30, 2023, the disclosure of which is herein incorporated by reference in its entirety.

### BACKGROUND ART

Currently, in a 5G core network, communication between an NF and an NF is processed through one service-based interface (SBI)-based protocol. Therefore, when a bottleneck or a failure occurs in a communicating NF, or when a delay or a failure occurs in a communication path between NFs, it is structurally inevitable that call processing between the corresponding NFs is subject to delay or failure.

Solutions addressing problems caused by such a structural constraint have not been proposed in the current B5G/6G standards, and no solution exists at present.

Therefore, in order to avoid problems due to the aforementioned structural constraint, there is a limitation in that NFs are generally required to be designed to operate with minimal issues, and switches/routers in the relevant paths are required to be purchased as high-performance systems.

Meanwhile, when a bottleneck occurs in a specific interface or protocol, an NF currently merely uses a retransmission technique based on re-try, and thus a significant amount of time is consumed for timeout recognition (e.g., 0.1 seconds, 1 second, 2 seconds, . . . , 54 minutes or more).

That is, in the 5G core network having the aforementioned structural constraint, when a bottleneck occurs in one NF, the bottleneck in the one NF acts as a cascading network delay factor, and as a result, the bottleneck acts as a delay factor affecting all aspects such as call processing, connection time, QoS, and mobility management for terminals/base stations, which may lead to a network failure situation.

In the present disclosure, a new technical method is proposed to enable processing through multiple interfaces during communication between NFs, thereby addressing various problems which may be caused by a structural constraint in which communication between NFs is processed through one interface.

### DISCLOSURE OF INVENTION

### Technical Problem

The task to be solved in the present disclosure is to realize a new technical method which enables processing through multiple interfaces during communication between NFs, departing from a structural constraint in which communication between NFs is processed through one interface.

### Solution to Problem

A network function (NF) device according to an embodiment of the present disclosure may include a duplication service-based interface (SBI) message (DSBIM) controller configured to perform a DSBIM operation according to preconfigured DSBIM information during communication between the NF device and another NF, wherein the DSBIM operation is an operation of duplicating an origin SBI message from the NF device to said another NF and redundantly transmitting the duplicated SBI message.

Specifically, the DSBIM controller may be configured to, while redundantly transmitting the duplicated SBI message, change the DSBIM operation according to at least one of information on a DSBIM mode delivered from a specific external NF, a state of the NF device, a state of said another NF, a network state, and an interface state.

Specifically, the DSBIM controller may be configured to, when transmitting an SBI message to said another NF, determine whether to redundantly transmit the duplicated SBI message, according to a DSBIM mode of DSBIM information activated in said another NF, and transmit the duplicated SBI message.

Specifically, the DSBIM controller may be configured to, during the communication between the NF device and said another NF, recognize an individual SBI message for a redundant SBI message, and perform the DSBIM operation by processing the recognized SBI message under a condition according to an activated DSBIM mode of DSBIM information shared between the NF device and said another NF.

Specifically, the DSBIM controller may be configured to pre-perform a procedure for the DSBIM operation with a specific NF, wherein the procedure for the DSBIM operation includes a process of delivering DSBIM information of the NF device to the specific NF so as to enable information on an activated DSBIM mode between the NF device and said another NF to be shared based on the specific NF.

Specifically, the DSBIM controller may be configured to generate a redundant SBI channel to said another NF for redundantly transmitting the duplicated SBI message, according to the activated DSBIM mode, wherein the redundant SBI channel is an SBI channel additionally configured between the NF device and said another NF in a peer-to-peer manner to transmit each duplicated SBI message in addition to the origin SBI message.

A terminal device according to an embodiment of the present disclosure includes: a communication unit configured to perform communication by using a service-based interface (SBI) message according to an SBI between network functions (NFs); and a duplication service-based interface (SBI) message (DSBIM) controller configured to, during communication with another NF, perform a DSBIM operation of duplicating an origin SBI message according to preconfigured DSBIM information and redundantly transmit the duplicated SBI message.

Specifically, the DSBIM controller may be configured to determine whether to activate the DSBIM operation in response to handover of the terminal device, in response to entering a specific coverage, or according to terminal slice information, an emergency mode, or a battery state.

A signaling control method performed by a network function (NF) according to an embodiment of the present disclosure may include a duplication service-based interface (SBI) message (DSBIM) operation performance operation of performing a DSBIM operation according to preconfigured DSBIM information during communication between the NF and another NF, wherein the DSBIM operation is an operation of duplicating an origin SBI message from the NF to said another NF and redundantly transmitting the duplicated SBI message.

A network function (NF) device according to an embodiment of the present disclosure may include: a memory including an instruction; and a processor configured to execute the instruction so as to perform a duplication service-based interface (SBI) message (DSBIM) operation according to preconfigured DSBIM information during communication between the NF device and another NF, wherein the DSBIM operation is an operation of duplicating an origin SBI message from the NF device to said another NF and redundantly transmitting the duplicated SBI message.

### Advantageous Effects of Invention

According to embodiments of the present disclosure, a specific technical configuration which enables processing through multiple interfaces during communication between NFs, departing from a structural constraint in which communication between NFs is processed through one interface is realized.

As such, in the present disclosure, by realizing a new technical method which enables processing through multiple interfaces during communication between NFs, an effect of alleviating/resolving various problems which may be caused by a conventional structural constraint in which communication between NFs is processed through one interface is achieved.

### BRIEF DESCRIPTION OF DRAWINGS

FIG. 1 is an exemplary diagram illustrating an example of a problem situation caused in a conventional structure in which communication between NFs is processed through one interface.

FIG. 2 is an exemplary diagram illustrating an NF and a core feature to which the present disclosure may be applied.

FIGS. 3 and 4 are block diagrams illustrating a configuration of an NF device according to an embodiment of the present disclosure.

FIG. 5 is an exemplary diagram illustrating a configuration of a DSBIM device implemented in an NF device of the present disclosure.

FIG. 6 is an exemplary diagram illustrating a configuration of DSBIM information presented in the present disclosure.

FIG. 7 is an exemplary diagram illustrating a configuration of DSBIM channel information presented in the present disclosure.

FIG. 8 is an exemplary diagram illustrating an NF binding level to which the present disclosure is applied.

FIG. 9 is an exemplary diagram defining an SBI message value managed by an NF to which the present disclosure is applied.

FIGS. 10 and 13 are flowcharts illustrating a signaling control method performed by an NF according to an embodiment of the present disclosure.

FIGS. 11, 12, and 14 illustrate embodiments of call flow proceeding according to a signaling control method performed by an NF of the present disclosure.

### MODE FOR CARRYING OUT THE INVENTION

Hereinafter, various embodiments of the present disclosure will be described with reference to the accompanying drawings.

The present disclosure relates to a technology which enables processing through multiple interfaces during communication between network functions (NFs).

5G defines a network structure for supporting a user equipment (UE), a base station (access), a core, and a server in an end to end manner. Further, 5G defines a network structure in which a control plane for a control signaling function and a user plane for a data transmission/reception function are divided by separating a control signaling function and a data transmission/reception function that have been complexly performed by a single node (e.g., S-GW, P-GW, etc.) in the existing LTE (4G).

In this case, in 5G, a node of a control plane (CP) may be defined as an access and mobility management function (AMF) that controls radio section access of a UE, a policy control function (PCF) that manages/controls policies such as subscribed service information, charging, and the like for each UE and UE information, a session management function (SMF) that controls/manages a session for using a data service for each UE, a network exposure function (NEF) that is in charge of a function of sharing information with an external network, an unified data management/authentication function (UDM/AUSF) that manages/controls a user's subscriber DB and authentication, a network repository function (NRF) that manages/controls information on each network function (NF) in a network, a charging function (CHF) that processes subscriber charging, a network data analytics function (NWDAF) that collects and analyzes various network data, and the like.

Further, in 5G, a node of a user plane (UP) may be defined as a user plane function (UPF) that performs data transmission or reception between a UE and a server in an external service network (e.g., Internet) via a session with the UE based on the control by (interoperation with) an SMF.

In 5G, a control node of the control plane and a data node of the user plane may be collectively referred to as network functions (NFs).

That is, 5G defines network functions (NFs) which perform specific functions in the control plane and the user plane, and defines that NFs interwork with each other through a service-based interface (SBI).

Meanwhile, recently, research is being conducted to evolve a user equipment (UE) into the 5G architecture and implement the UE as an NF, so that not only the NFs in the control plane and the user plane but also the UE (hereinafter, a UENF) communicate in a unified manner using an SBI.

The present disclosure relates to a technology which enables processing through multiple interfaces during communication between the above-described NFs (e.g., UENF, RANF, AMF, SMF, UPF, etc.).

Currently, in 5G, communication between an NF and an NF is processed through one service-based interface (SBI) based protocol. Therefore, when a bottleneck or a failure occurs in a communicating NF, or when a delay or a failure occurs in a communication path between NFs, it becomes structurally inevitable that call processing between the corresponding NFs will be delayed or fail.

Solutions addressing problems caused by such a structural constraint of 5G have not been proposed in the current B5G/6G standards, and no solution exists at present.

Therefore, in order to avoid problems due to the aforementioned structural constraint of 5G, there is a limitation in that NFs are generally required to be designed to operate with minimal issues, and switches/routers in the relevant paths are required to be purchased as high-performance systems.

Meanwhile, when a bottleneck occurs in a specific interface or protocol, an NF currently merely uses a retransmission technique based on re-try, and thus a significant amount of time is consumed for timeout recognition (e.g., 0.1 seconds, 1 second, 2 seconds, . . . , 54 minutes or more).

That is, when a bottleneck occurs in one NF, the bottleneck in the one NF acts as a cascading network delay factor, and as a result, the bottleneck acts as a delay factor affecting all aspects such as call processing, connection time, QoS, and mobility management for terminals/base stations, which may lead to a network failure situation.

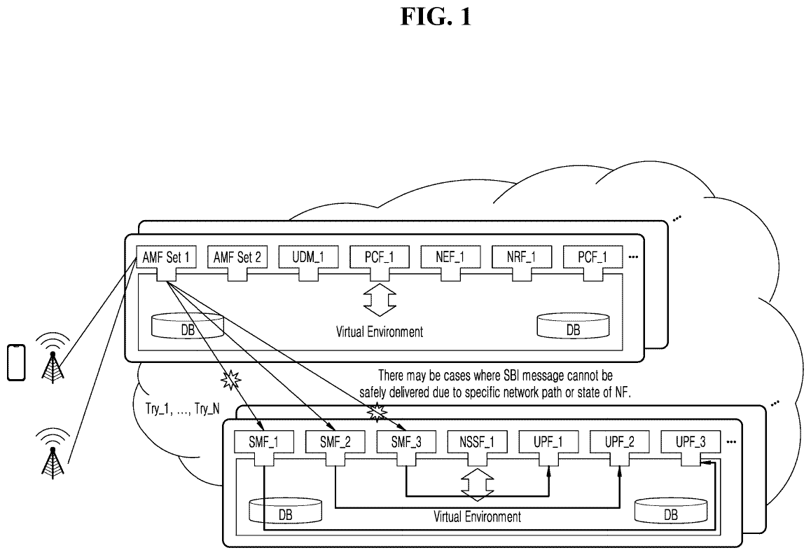

Furthermore, referring to FIG. 1, a next-generation core network is implemented to include a virtualized data center.

Accordingly, a large number of AMFs, SMFs, UPFs, and NFs may exist, and each NF may be uniquely identified based on an ID. In addition, as container technology has been continuously developed, the size of NFs has decreased, evolving into a structure that includes only necessary features.

That is, NFs such as an AMF, SMF, UPF, and the like may have at least tens of thousands to eleven million IDs, and may be individually installed inside or outside different data centers. In such a structure, multiple NFs including AMFs are required to be able to connect a UE to the network more quickly and provide services more quickly.

However, as can be seen in FIG. 1, in the evolving 5G cloud/data center structure as well, when a delay or the like occurs in a specific path (interface) or an NF, and a bottleneck or a failure occurs accordingly, there is no alternative method other than the conventional retransmission technique based on re-try.

Due to this, a network failure situation such as a delay or quality degradation caused by structural constraints of 5G, such as an SBI message not being securely delivered, is inevitable.

Accordingly, the present disclosure proposes a new technical method which enables processing through multiple interfaces during communication between NFs, so as to address various problems which may be caused by a conventional structural constraint of 5G in which communication between NFs is processed through one interface.

More specifically, in 5G SA, there are a large number of NFs in a call flow, and in particular, there are many cases in which an NF is required to select another NF (that is, a call processing operation between NFs).

Although there are basic information conditions for NF selection, a structure is such that when an NF attempts to select another NF in the call flow, there is no other choice but to wait until the corresponding NF selection is completed or terminated (and an error occurs).

In addition, in a situation in which various E2E networks such as cloud/data centers currently exist, various virtual/physical paths and various switches/routers coexist, and thus, a structure is such that link speed/delay are inevitably different.

In addition, in the call flow, there are processes in which, until completion of the selection/attempt of another NF by an NF, the selected/attempted other NF is required to also select and complete additional other NFs, and thus a selection-completion time does not follow a simple 1-hop structure.

Due to this, in the present disclosure, a specific technical configuration which enables processing through multiple interfaces during communication between NFs, departing from a conventional structural constraint of 5G in which communication between NFs is processed through one interface is realized, so that an effect of alleviating/resolving various problems which may be caused by a conventional structural constraint of 5G is derived.

In the following description, a “technical method which enables processing through multiple interfaces during communication between NFs” as realized in the present disclosure is referred to as a “duplication SBI message (DSBIM) operation”, but is not limited to this term.

In addition, in the present disclosure, a domain of a function in which a duplicated SBI message is transmitted by a DSBIM operation may be defined as a “redundant control plane”, “duplicated signal”, “copied service-based interface signaling message”, “redundant control plane tunnel”, “replicated SBI message”, etc., but the present disclosure is not limited to these definitions.

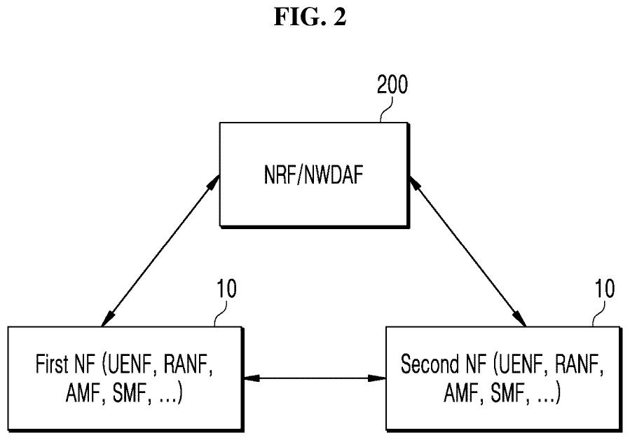

First, referring to FIG. 2, a core feature of the present disclosure will be briefly described below.

An NF to which the present disclosure may be applied may be a core NF such as an AMF, SMF, etc., but is not limited thereto and may also be an RANF, and may also be a UE (hereinafter, a UENF) implemented as an NF to communicate using an SBI.

Therefore, the technical method proposed in the present disclosure, that is, a DSBIM operation, may be applied to all NFs (e.g., UENF, RANF, AMF, SMF, UPF, etc.) which use inter-NF communication by transmitting and receiving SBI messages with each other, as shown in FIG. 2.

Further, in the present disclosure, NRF, NWDAF, and NEF may be used as specific NFs supporting a procedure for a DSBIM operation between NFs.

However, as an example, FIG. 2 illustrates a first NF and a second NF as subject NFs 10 which perform a DSBIM operation of the present disclosure, and illustrates an NRF/NWDAF 200 as a specific NF which supports a procedure for a DSBIM operation between NFs.

Particularly, the present disclosure will discuss a function of performing/processing a DSBIM operation between NFs 10 (a first/a second NF).

To this end, first, the DSBIM operation proposed in the present disclosure will be briefly described with reference to FIG. 2.

According to the DSBIM operation proposed in the present disclosure, the first NF may duplicate one origin SBI message transmitted to the second NF according to various states/conditions to generate multiple duplicated SBI messages, and may transmit (redundantly transmit) the duplicated SBI messages to the second NF.

The first NF may duplicate an origin SBI message in various manners according to a mode of the DSBIM operation (hereinafter, a DSBIM mode), and may redundantly transmit the duplicated SBI messages (via multiple paths, to multiple locations, to different destination IPs, etc.).

The second NF, which receives the duplicated SBI messages, processes the SBI messages according to a predefined DSBIM mode.

The second NF having received the SBI messages may also duplicate an SBI message of a response transmitted to the first NF, and transmit (redundantly transmit) multiple duplicated SBI messages.

For example, the DSBIM operation may be performed identically on both an SBI message of a request and an SBI message of a response, or may be performed separately on each.

In addition, the second NF may, if necessary and for achieving higher reliability, perform additional DSBIM operation propagation to a third NF.

As described above, in order to perform the DSBIM operation between the NFs 10 (e.g., UENF, RANF, AMF, SMF, UPF, etc.), each NF 10 transmits detailed information such as whether a DSBIM is supported, DSBIM information, an activated DSBIM mode, etc., during an NF registration procedure in which information of a corresponding NF itself is registered with the initial NRF 200.

Therefore, the NRF/NWDAF 200 may identify a current section in which a DSBIM occurs and information on an NF capable of processing the DSBIM, based on corresponding information of each NF 10.

The NF 10 (e.g., UENF, RANF, AMF, SMF, UPF, etc.) may basically have at least two SBI channels (e.g., N-tuple-based Layer 2 to Layer 4 connections for transmitting and receiving an SBI message) in order to transmit/receive multiple duplicated SBI messages, i.e., DSBIMs.

For example, from the perspective of the NF 10 which performs the DSBIM operation, the first NF may be an AMF, and the second NF may be an SMF.

Typically, the reason why an AMF is exemplified as the first NF is that a core NF to be first accessed after the UE/base station is the AMF, and the present disclosure is not limited thereto.

In addition, in the present disclosure, a hop count such as 1-hop, 2-hop, etc. may be determined according to DSBIM information so that no additional DSBIM operation propagation is continued upon each SBI message transmission, and a count (number) or time (duration) may be determined to stably control so that no unnecessary duplicated SBI messages flow in the network.

As such, in order to realize the technical scheme proposed in the present disclosure, that is, the DSBIM operation, the DSBIM operation may be classified into a processing operation between an NF and an NF which perform the DSBIM operation, and a processing operation between an NF and a specific NF for the DSBIM operation.

The processing operation between an NF and an NF which perform the DSBIM operation: a processing operation between an NF 10 and an NF 10 in which, when communicating with a second NF, a first NF duplicates an origin SBI message and transmits the message as a duplicated SBI message.

The processing operation between an NF and a specific NF for the DSBIM operation: a processing operation between each NF 10 (e.g., UENF, RANF, AMF, SMF, UPF, etc.) which performs the DSBIM operation and a specific NF 200 (e.g., NRF, NWDAF, NER, etc.), wherein a procedure for the DSBIM operation is performed/processed.

In particular, in the present disclosure, a processing operation between NFs which perform the DSBIM operation will be described.

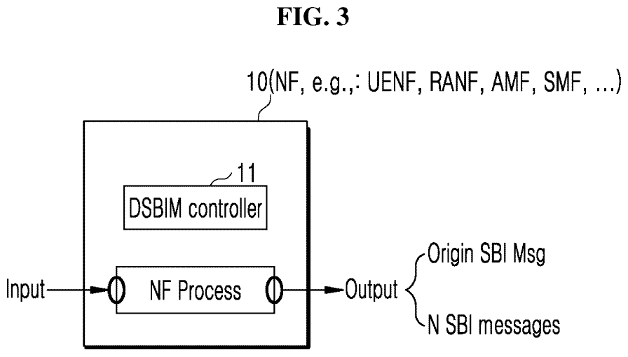

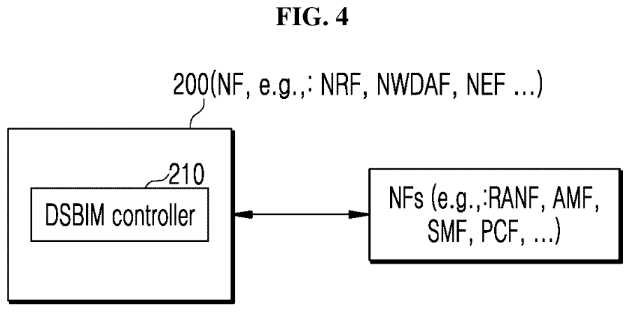

FIG. 3 and FIG. 4 illustrate a configuration of an NF device according to an embodiment of the present disclosure.

FIG. 3 illustrates the viewpoint of each NF 10 (e.g., UENF, RANF, AMF, SMF, UPF, etc.) which performs a DSBIM operation, and FIG. 4 illustrates the viewpoint of a specific NF 200 (e.g., NRF, NWDAF, NEF, etc.) which supports a procedure for a DSBIM operation between NFs 10.

In the following description, in relation to the present disclosure, a specific embodiment will be described from the viewpoint of a processing operation between an NF and an NRF/NWDAF which perform/process a procedure for a DSBIM operation.

Referring to FIG. 3, an NF device 10 according to an embodiment of the present disclosure includes a DSBIM controller 11 responsible for performing a procedure for a DSBIM operation together with a specific NF 200 (e.g., NRF, NWDAF, NEF, etc.).

The NF device 10 includes an SBI module for transmitting and receiving an SBI message, and the SBI module basically performs reception (input, receive, ingress), processing (NF process), and transmission (send, egress).

Here, a message (SBI message) interfaced by the SBI module refers to a data packet including headers of an application layer such as HTTP, HTTP/2, and QUIC defined in SBI.

In the NF device 10 of the present disclosure, the DSBIM controller 11 may perform a procedure for a DSBIM operation of duplicating an origin SBI message from the NF 10 to a target NF and redundantly transmitting the duplicated message, together with a specific NF 200 (e.g., NRF, NWDAF, NEF, etc.).

The DSBIM controller 11 is responsible for performing, with a specific NF 200 (e.g., NRF, NWDAF, NEF, etc.), a procedure for a DSBIM operation, that is, a preliminary procedure necessary for performing a DSBIM operation with respect to an origin SBI message generated by the SBI module.

Here, from the viewpoint of an NF 10 (e.g., UENF, RANF, AMF, SMF, UPF, etc.) to which the present disclosure is applied, the target NF refers to an NF 10 (e.g., UENF, RANF, AMF, SMF, UPF, etc.) that is a reception target of an SBI message transmitted by another NF 10.

That is, as described above, with reference to communication between a first NF and a second NF, the second NF corresponds to a target NF from the viewpoint of the first NF, and the first NF or another third NF may correspond to a target NF from the viewpoint of the second NF.

Before a detailed description, key terms mentioned in the present disclosure will be described.

DSBIM refers to a duplicated SBI message.

Functionally, DSBIM refers to duplicating one origin SBI message into multiple (N) SBI messages and transmitting the duplicated SBI messages redundantly.

Here, an SBI message is defined as one SBI message having the same service name, service operation, and attribute type, and N SBI messages mean that the origin SBI message is duplicated based on specific information.

Here, the term “duplication” may refer to duplication in which a target message (origin SBI message) is 100% duplicated, and may refer to duplication in which a duplication degree (e.g., 5% to 95%) of the content of the target message (origin SBI Message) is configured/duplicated according to a specific DSBIM mode.

DSBIM information refers to a processing (transmission/reception) criterion and method for a DSBIM operation of duplicating an origin SBI message into a duplicated SBI message.

NFs (a first NF and a second NF), which mutually perform a DSBIM operation, commonly have DSBIM information (information on a DSBIM mode), so that the NFs may need to be aware of which information is redundant and which is not redundant, and how a DSBIM is required to be interpreted.

The DSBIM information (information on the DSBIM mode) may be regarded as a policy regarding how duplication is to be performed for a specific SBI message.

The DSBIM mode refers to a configuration mode for a duplicated SBI message, and refers to an operation of actually duplicating a target message (origin SBI message) to perform duplication.

For example, the DSBIM mode may include a configuration for generating duplication into N SBI messages, a configuration for splitting each SBI message to determine which part is to be duplicated, a configuration for specifying a range and a context within the SBI message to determine exactly a position from which and a position to which duplication is to be performed, a configuration for a transmission path to a target NF (e.g., layer 2 (MAC), 3 (IP), 4 (TCP/UDP) address), and a configuration for a duplication processing method (e.g., a compression mode, a transmission ratio for each of N paths (e.g., 50:50 or 80:20 for two paths), and the like).

The following specific description may be understood with reference to the key terms mentioned in the present disclosure described above.

Continuing the description, the DSBIM controller 11 performs a procedure for a DSBIM operation in the NF 10 with a specific NF 200 (e.g., NRF, NWDAF, NEF, etc.).

In this case, the procedure for the DSBIM operation according to the present disclosure is a procedure of delivering DSBIM information of the NF 10 to the specific NF 200 (e.g., NRF, NWDAF, NEF, etc.), so that based on the specific NF 200 (e.g., NRF, NWDAF, NEF, etc.), duplicated SBI messages are redundantly transmitted according to an activated DSBIM mode between the NF 10 (e.g., a first NF) and another NF (e.g., a second NF).

More specifically, the procedure for the DSBIM operation according to the present disclosure may include a process of delivering DSBIM information of the NF 10 to the specific NF 200 (e.g., NRF, NWDAF, NEF, etc.), so as to enable information on an activated DSBIM mode between the NF 10 (e.g., the first NF) and another NF (e.g., the second NF) to be shared based on the specific NF 200 (e.g., NRF, NWDAF, NEF, etc.).

Thus, the procedure for the DSBIM operation according to the present disclosure may enable a duplicated SBI message to be redundantly transmitted according to a mutually activated DSBIM mode.

More specifically, the procedure for the DSBIM operation may include: a step in which the NF 10 (e.g., the first NF) delivers DSBIM information of the NF 10 (e.g., the first NF) to the specific NF 200 (e.g., NRF, NWDAF, NEF, etc.) through NF registration or NF update; and a step in which the specific NF 200 (e.g., NRF, NWDAF, NEF, etc.) selects a DSBIM mode activatable in the corresponding NF 10 (e.g., the first NF) with respect to the delivered DSBIM information and notifies the NF 10 of the selected mode.

In addition, the procedure for DSBIM operation may include a step in which the specific NF 200 (e.g., NRF, NWDAF, NEF, etc.) notifies another NF (e.g., the second NF) of information on an activatable DSBIM mode of the NF 10 (e.g., the first NF) when the specific NF 200 (e.g., NRF, NWDAF, NEF, etc.) delivers the NF 10 (e.g., the first NF) as a response to an NF discovery from the other NF (e.g., the second NF) or an NF notification to the other NF (e.g., the second NF).

According to the procedure for the DSBIM operation as described above, and according to a processing operation between an NF and an NRF/NWDAF as addressed in the present disclosure, DSBIM information (e.g., detailed information such as whether a DSBIM is supported, DSBIM information, an activated DSBIM mode, etc.) of each NF 10 may be delivered to the specific NF 200 (e.g., NRF, NWDAF, NEF, etc.) through NF registration.

Therefore, the specific NF 200 (e.g., NRF, NWDAF, NEF, etc.) may manage DSBIM information (e.g., detailed information such as whether a DSBIM is supported, DSBIM information, an activated DSBIM mode, etc.) of each NF 10.

In addition, the specific NF 200 (e.g., NRF, NWDAF, NEF, etc.) may apply a local policy to the corresponding content of the DSBIM information delivered from each NF 10, and select and notify each NF 10 of an activatable DSBIM mode, so as to configure the DSBIM mode for each NF 10.

In addition, according to the processing operation between the NF and the NRF/NWDAF as addressed in the present disclosure, each NF 10 may request an update of its DSBIM information (e.g., information on a DSBIM mode) from the specific NF 200 (e.g., NRF, NWDAF, NEF, etc.) through an NF update according to network state monitoring/awareness.

Therefore, the specific NF 200 (e.g., NRF, NWDAF, NEF, etc.) may apply a local policy to the NF update from the NF 10 to change/select a DSBIM mode and notify the corresponding NF 10 of the DSBIM mode, so as to change/configure the DSBIM mode for each NF 10.

According to the processing between the NF and the NRF/NWDAF as addressed in the present disclosure, DSBIM information (information on a DSBIM mode) of each NF 10 may be changed/configured by the specific NF 200 (e.g., NRF, NWDAF, NEF, etc.).

Meanwhile, by the procedure for the DSBIM operation as described above, according to the processing between the NF and the NRF/NWDAF as addressed in the present disclosure, when an NF 10 (e.g., the first NF) as a producer discovered/selected in response to an NF discovery of an NF 10 (e.g., the second NF) as a consumer is delivered, information on an activatable DSBIM mode of the producer NF 10 (e.g., the first NF) may be notified to the consumer NF 10 (e.g., the second NF).

Therefore, the consumer and producer NFs (e.g., the first and second NFs), which will subsequently perform the DSBIM operation mutually, may share/commonly have DSBIM information (e.g., information on a DSBIM mode).

In addition, according to the processing between the NF and the NRF/NWDAF as addressed in the present disclosure, when the NF 10 (e.g., the second NF) delivers the NF 10 (e.g., the first NF) as an NF notification according to a specific event regarding the NF 10 (e.g., the first NF) to which the NF 10 (e.g., the second NF) has previously subscribed, the NRF/NWDAF may notify the NF (e.g., the second NF) of the information on the activatable DSBIM mode of the NF 10 (e.g., the first NF).

Therefore, the NFs (e.g., the first and second NFs), which will subsequently perform the DSBIM operation mutually, may share/commonly have the latest DSBIM information (information on the DSBIM mode).

As such, the DSBIM controller 11 in the NF device 10 according to the present disclosure may acquire information on a DSBIM mode that can be activated in the NF 10 from the specific NF 200 (e.g., NRF, NWDAF, NEF, etc.) through the procedure for the DSBIM operation (the processing operation between the NF and the NRF/NWDAF), and thus the NFs, which will mutually perform the DSBIM operation, may share/commonly have DSBIM information (information on a DSBIM mode).

Next, a specific embodiment from the viewpoint of a processing operation between an NF and an NF which perform/process a DSBIM operation according to the present disclosure will be described.

Referring to FIG. 3, the NF device 10 according to an embodiment of the present disclosure may include: a memory (not shown) including an instruction; and a processor (the DSBIM controller 11 of FIG. 3) which performs a DSBIM operation according to preconfigured DSBIM information during communication between an NF 10 (e.g., a first NF) and another NF 10 (e.g., a second NF).

Such a DSBIM controller 11 may be the DSBIM controller 11 described in the embodiment from the viewpoint of a processing operation between an NF and an NRF/NWDAF described above.

More specifically, if a specific embodiment is described, the DSBIM controller 11 may determine, when transmitting an SBI message to another NF 10 (e.g., the second NF), whether to redundantly transmit a duplicated SBI message, according to the acquired DSBIM information (information on a DSBIM mode) and according to an activated DSBIM mode of the DSBIM information shared with the other NF 10 (e.g., the second NF), and may transmit the message.

That is, based on the activated DSBIM mode of the DSBIM information acquired through a preliminary procedure necessary for performing the DSBIM operation and shared with the other NF 10 (e.g., the second NF), the DSBIM controller 11 may duplicate an origin SBI message and transmit N duplicated SBI messages if both the NF 10 (e.g., the first NF) and the other NF 10 (e.g., the second NF) are be able to process the DSBIM operation (DSBIM mode) with respect to a target message (origin SBI message) to be transmitted to the other NF (e.g., the second NF).

If, based on the activated DSBIM mode of the DSBIM information shared with the other NF (e.g., the second NF), the DSBIM controller 11 determines that a DSBIM operation (DSBIM mode) cannot be processed (unsupported) by the NF 10 (e.g., the first NF) or the other NF (e.g., the second NF) for the target message (origin SBI message) to be transmitted to the other NF (e.g., the second NF), the DSBIM controller 11 may transmit only one origin SBI message.

More specifically, the DSBIM controller 11 may, during communication between the NF 10 (e.g., the first NF) and the other NF 10 (e.g., the second NF), recognize an individual SBI message for a duplicated SBI message and process the recognized SBI message under a condition according to the activated DSBIM mode of the DSBIM information shared between the NF 10 (e.g., the first NF) and the other NF 10 (e.g., the second NF), so as to perform the DSBIM operation.

That is, the DSBIM controller 11 may perform the DSBIM operation by distinguishing a session which requires a DSBIM operation, through recognition of the individual SBI message, and then duplicating an SBI message of the corresponding session under a condition according to the activated DSBIM mode for the corresponding session and redundantly transmitting the duplicated message.

As described above, according to the present disclosure, during communication between NFs (the first and second NFs), an SBI message is duplicated (duplication) and redundantly transmitted so as to enable processing through multiple interfaces, so that session duplication between NFs is realized.

Additionally, in the present disclosure, DSBIM information for each SBI message may be configured for session duplication (=DSBIM operation).

The configuration method may follow a method for configuring a duplication resource priority through each SBI message type, address, and reliability, as shown in table information.

The type of message is a session-related type, and a request and a response for each name may be distinguished. In addition, UEContext and NIN2 information included in the session type is distinguished. That is, all of [Service Name, Service Operation, Attribute, Data Type, . . . , value] corresponding to an SBI may be subjects to be considered.

In addition, in the present disclosure, according to duplication resource importance, a queue-processing scheduling method for an SBI message for each NF may be differently optimized. For example, optimization may be performed by differently configuring message per second control for each individual ranking.

There is also a resource required to process each SBI message detail. That is, if DSBIM operation processing for a specific session is more important, it is also possible to process a DSBIM operation of the corresponding session first.

In the present disclosure, it is possible to distinguish up to which NF the DSBIM operation of the corresponding session may be processed.

For example, an AMF may be able to perform session duplication (=DSBIM operation), and an SMF may also be able to perform session duplication (=DSBIM operation), but a PCF may not be able to process session duplication (=DSBIM operation).

In this case, only the AMF/SMF among the NFs involved in the corresponding session may process signaling for session duplication (=DSBIM operation).

In addition, session duplication (=DSBIM operation) capability for each NF may be mutually recognized through the above-described procedure for the DSBIM operation (the processing operation between the NF and the NRF/NWDAF).

That is, from the perspective of the AMF/SMF, when communication with the PCF, which does not support (is not able to perform) session duplication (=DSBIM operation), is required, the SMF may turn off the DSBIM operation of the corresponding session, and process signaling for transmission of one origin SBI message, without signaling for session duplication (=DSBIM operation).

As described above, in the present disclosure, the entire core network NFs may understand and process session duplication so that session duplication (=DSBIM operation) may be smoothly processed.

Furthermore, while redundantly transmitting a duplicated SBI message, the DSBIM controller 11 may change a DSBIM operation (e.g., activate or deactivate a DSBIM operation, change a DSBIM mode, etc.) according to at least one of information on a DSBIM mode delivered from an external specific NF 200 (e.g., NRF, NWDAF, NEF, etc.), a state of the NF device 10 (e.g., the first NF) itself, a state of the communicating other NF 10 (e.g., the second NF), a network state, and an interface state.

Specifically, the DSBIM controller 11 may change (e.g., turn on/off a DSBIM operation, change a DSBIM mode, etc.) the DSBIM operation according to a change in DSBIM information for the NF device 10 from the specific NF 200 (e.g., NRF, NWDAF, NEF, etc.).

For example, according to the processing operation between the NF and the NRF/NWDAF as addressed in the present disclosure, DSBIM information (information on a DSBIM mode) of each NF 10 (e.g., UENF, RANF, AMF, SMF, UPF, etc.) including the NF device 10 may be changed/configured according to on a change in DSBIM information from the specific NF 200 (e.g., NRF, NWDAF, NEF, etc.), so that the DSBIM operation may be changed (e.g., turning on/off the DSBIM operation, changing a DSBIM mode, etc.).

In addition, the DSBIM controller 11 may change (e.g., turn on/off a DSBIM operation, change a DSBIM mode, etc.) a DSBIM operation with the other NF 10 (e.g., the second NF) transmitting a duplicated SBI message, based on at least one of a state of the NF device 10 (e.g., the first NF) itself, a state of the communicating other NF 10 (e.g., the second NF), a network state, and an interface state.

For example, the NF device 10 (e.g., the first NF) of the present disclosure may directly, or through the specific NF 200 (e.g., NRF, NWDAF, NEF, etc.), measure an interface state of SBA between individual NFs for the NF device 10 (e.g., the first NF), calculate an overload state/signaling storm with respect to the measured interface state, recognize a transaction per second (tps) of an individual SBI message, and thus measure a load state of the NF.

That is, the NF device 10 (e.g., the first NF) of the present disclosure may identify its own state, an interface state between individual NFs, and a real-time network state directly or through the specific NF 200 (e.g., NRF, NWDAF, NEF, etc.), and may further identify the state of the other NF 10 (e.g., the second NF) through the specific NF 200 (e.g., NRF, NWDAF, NEF, etc.).

Therefore, while redundantly transmitting a duplicated SBI message to the other NF 10 (e.g., the second NF), the DSBIM controller 11 may change (e.g., turn on/off a DSBIM operation, change a DSBIM mode, etc.) a DSBIM operation with the other NF 10 (e.g., the second NF), based on the above-described identified information.

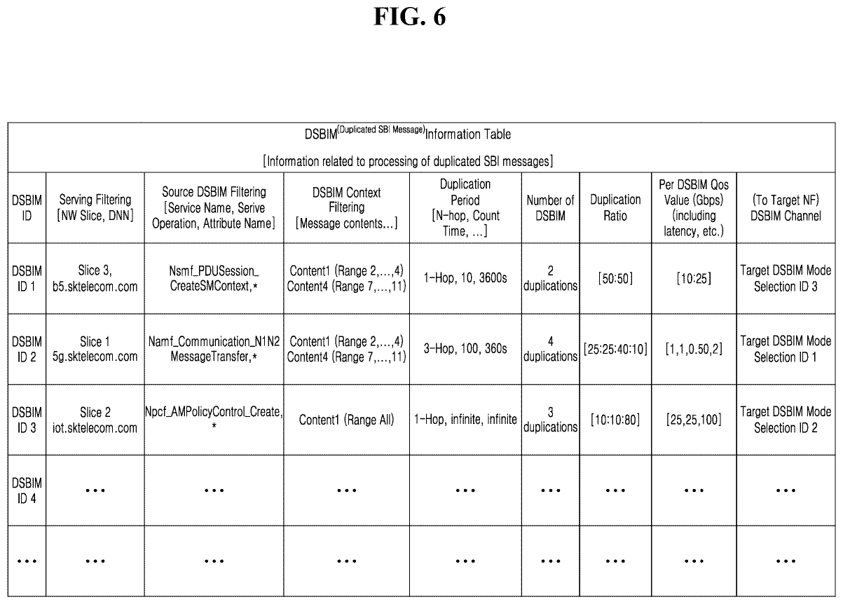

More specifically, in the present disclosure, when the NF 10 (e.g., the first NF) transmits N duplicated SBI messages, the corresponding SBI protocol (e.g., HTTP/2, HTTP/3) may include DSBIM information (e.g., a DSBIM indicator, referring to FIG. 6 below) and, accordingly, a target NF 10 (e.g., the second NF) may process the duplicated SBI messages, based on the corresponding information.

The operation of processing duplicated SBI messages (e.g., N messages→1 origin message) at the target NF 10 (e.g., the second NF) may be variously implemented.

For example, the target NF 10 (e.g., the second NF) may process duplicated SBI messages in a manner opposite to that of the DSBIM information in which the duplicated SBI messages are generated and transmitted by the NF 10 (e.g., the first NF) to obtain an origin SBI message, and in addition, the target NF may reliably remove redundancy of SBI messages by employing a First-In-First-Served scheme, or by receiving N partial or all N SBI messages and then performing a validation/verification (Store & Forward) scheme.

In addition, since each duplicated SBI message has its own SBI MSG sequence ID, the target NF 10 (e.g., the second NF) receiving the duplicated SBI messages may determine whether an SBI message is redundantly received, based on the SBI MSG sequence ID, and may determine whether to generate and transmit an additional duplicated SBI message, or to deactivate (terminate) the DSBIM operation.

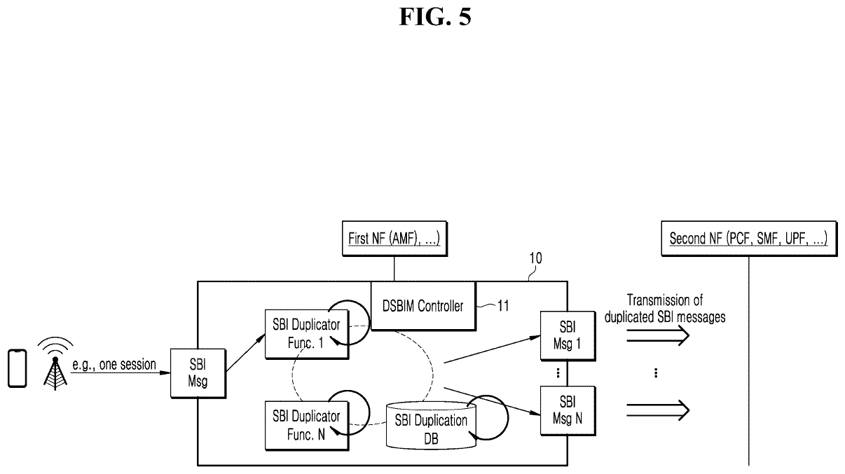

In the following description, a detailed example of a configuration of a separate device (module) implemented in the NF device 10 to process the DSBIM operation of the present disclosure will be described with reference to FIG. 5.

As shown in FIG. 5, a separate device (module) for processing a DSBIM operation may be implemented in an NF device 10 of the present disclosure, and will be described as a DSBIM device for convenience of description.

As described in the above embodiments where the AMF is referred to as the first NF, the DSBIM device implemented in the NF device 10 for processing the DSBIM operation may be mounted on each NF 10 (e.g., an NF consumer/NF producer, UENF, RANF, AMF, SMF, UPF, etc.), and may operate with various detailed functions for processing the DSBIM operation within the mounted NF.

To this end, the DSBIM device may be divided into a DSBIM controller, an SBI duplicator function, and an SBI duplication DB.

The overall DSBIM operation processing is controlled by a DSBIM controller 11 operating within the NF, and the DSBIM controller 11 may be the same as the DSBIM controller 11 described above.

The SBI duplicator function is a module for duplicating one SBI message into multiple SBI messages.

When the SBI duplicator function receives one SBI message, the SBI duplicator function configures duplication policies according to a DSBIM mode (or duplication mode) from the DSBIM controller and multiple SBI DSBIM details. That is, the SBI duplicator function determines which part of the SBI DSBIM is to be duplicated (duplication).

The DSBIM controller controls the overall operation processing for duplicating an SBI message according to an actual preconfigured DSBIM mode (or duplication mode).

The SBI duplication DB may manage information for duplicating an SBI message and processing the message as a duplicated SBI message, and manage DSBIM information, information on a DSBIM mode, a policy from a specific NF 200 (e.g., NRF, NWDAF, NEF, etc.), and multiple SBI DSBIM details.

The SBI duplication DB may activate receiving information/policy from the specific NF 200 (e.g., NRF, NWDAF, NEF, etc.), and save/load information according to a network condition during communication between NFs, so as to perform duplication of SBI messages.

Therefore, in the NF device 10 equipped with the DSBIM device according to the present disclosure, for one SBI message input, N duplicated SBI messages may be transmitted (output) to the second NF (e.g., PCF, SMF, UPF, etc.) through the DSBIM operation process according to the activated DSBIM mode.

For reference, session duplication (=DSBIM operation) implemented in the present disclosure is different from dual registration in terms of technical implementation, and refers to signaling processing for transmitting duplicated SBI messages to enhance reliability within the core network.

Meanwhile, the NF device 10 to which the present disclosure is applied may consider, as conditions for performing session duplication (=DSBIM operation), not only a UE state and a service requirement but also a bandwidth state and a QoS quality state between NFs in real time, and may determine whether to perform the session duplication.

For example, the NF device 10 to which the present disclosure is applied may measure an interface state of an SBA between individual NFs, calculate an overload state/signaling storm with respect to the interface state, and recognize transaction per second (tps) of the individual SBI messages to measure a load state of the NF. That is, a condition for performing session duplication (=DSBIM operation) may be established according to a real-time network state.

According to such a real-time network state, the NF device 10 to which the present disclosure is applied may determine (yes/no) whether to perform session duplication (=DSBIM operation) during NF-to-NF communication, and subsequently notify the specific NF 200 thereof.

FIG. 6 is an exemplary diagram illustrating a configuration of DSBIM information presented in the present disclosure.

According to a procedure (that is, a processing operation between an NF and an NRF/NWDAF) for a DSBIM operation of the present disclosure, DSBIM information (information on a DSBIM mode) may be delivered between an NF 10 and an NRF/NWDAF 200, and may be delivered in a table form as shown in Table 6 below.

Each piece of information is described in detail as follows.

### DSBIM ID

In the present disclosure, basically, when a duplicated SBI message is generated, a corresponding ID is assigned. This ID may be regarded as indicating a policy which has been determined for performing the DSBIM operation (duplicate processing). That is, the DSBIM ID may serve to provide an indication for a duplicated SBI message.

That is, when one SBI message serves as an input (or trigger condition), a specific DSBIM ID is selected as a criterion for duplicating the corresponding SBI message to generate a duplicated SBI message (e.g., the same UE type/location/slice, etc.), and DSBIM operation processing is performed according to a policy corresponding to the selected specific DSBIM ID.

### Source DSBIM Filtering

This content represents an input/trigger condition for determining when duplication is to be performed for a specific SBI message, and in FIG. 6, such a condition is defined as a 3-tuple combination of a specific service name, service operation, and attribute name. In addition, a wildcard may also be used, and may be defined as a 1-tuple, a 2-tuple, or the like.

For example, if only the service name is specified, and * is present in the remaining service operation and attribute name, the DSBIM operation (duplicate processing) may be refined to be performed only based on the specific service name.

The reason for performing/defining the same is that the NF does not generate/transmit duplicated SBI messages for all SBI messages.

That is, in the case of transmission and reception of a duplicated SBI message between an NF and an NF, instead of performing the DSBIM operation (duplicate processing) for all SBI messages, the DSBIM operation (duplicate processing) of the present disclosure is selectively performed/processed for a specific important service name (e.g., Nsmf_PDUSession) based on the priority (e.g., high/medium/low, etc.) according to the importance, as necessary.

### DSBIM Context Filtering

This content provides a criterion for determining which part of the actual SBI message content (or context information) is to be duplicated.

For example, if the entire SBI message (100%) is to be duplicated, it may be distinguished/defined as Content1 (Range ALL), and if only a specific content in the SBI message needs to be duplicated according to a specific situation, a content range may be divided into content1, content2, etc., and a range of start-end for each content may be defined.

This also has a feature of performing/processing only a part of the SBI message through the DSBIM operation (duplication processing) and transmitting the same multiple times, according to the importance of an SBI message content (content or context information).
Duplication Period

This content refers to a period content for a duplicated SBI message, and may be configured by considering three units: a hop unit, a count unit, and a time unit.

For example, 1-Hop refers to generating/transmitting a duplicated SBI message only within a 1 hop range from a first NF to a second NF, and 3-Hop refers to generating a duplicated SBI message at the first NF and transmitting the message to the second NF, then generating and transmitting a duplicated SBI message from the second NF to a third NF, and from the third NF to a fourth NF, up to three hops. The number of hops may be reduced as the message passes through each NF.

Count refers to the total number of duplicated SBI messages generated/transmitted before termination (termination of duplicated SBI message generation), and time refers to terminating duplicated SBI message generation/transmission when a corresponding time has elapsed from the start. Here, time information is not limited to the example shown in FIG. 6, and may be determined using a real start, end time, or the like.

### Number of DSBIM

This content relates to the total number of duplicated SBI messages to be generated. For example, when the total number is set to 2, this indicates that two duplicated SBI messages are to be generated.

For reference, FIG. 6 illustrates the setting of the number, but the present disclosure is not limited thereto, and the number of SBI messages may be generally defined by a Min value (minimum number of duplicated SBI messages) and a Max value (maximum number of duplicated SBI messages). For example, when Min=2 and Max=5, it means that, when the first NF transmits a duplicated SBI message to the second NF, the first NF may generate duplicated SBI messages from a minimum of 2 to a maximum of 5 according to a network state.

### Duplication Ratio

This content relates to a priority (or weight) with which a duplicated SBI message is transmitted.

For example, when there are two possible transmission paths for a duplicated SBI message from the first NF to the second NF, the priority (e.g., 20:80) may be applied to select a path for the duplicated SBI message. That is, when two duplicated SBI messages are required to be transmitted and two paths exist, the SBI message may be transmitted with a smaller weight (20%) through the first path considering the network state (e.g., with a low latency and a high bandwidth/throughput) and transmitted with a larger weight (80%) through another path (having a relatively worse network state).

Such a duplication ratio may be configured in consideration of the network state.

For example, in the case of a low latency and a high bandwidth/throughput, a lower weight may be assigned compared to a relatively inferior path, to enable delivery of duplicated SBI messages while maintaining a priority and a relative superiority of a network environment.

The ratio illustrated in FIG. 6 also comprehensively takes sampling into account. That is, a duplication ratio represents information indicating sampling, and by configuring the duplication ratio, when a duplicated SBI message is transmitted depending on a specific network state or an NF state, the duplicated SBI message may be transmitted in a specific sampling manner (e.g., 1/10, 1/100, etc.) rather than being transmitted every time with a corresponding priority (or weight).

If the characteristics of such a complex duplication ratio are continued/applied, even when multiple SBI messages are transmitted through multiple network paths, a dynamic adjustment may be performed so that the number of SBI messages does not simply double (or increase N times), thereby enabling transmission of duplicated SBI messages.

### Per DSBIM QoS Value

This content relates to configuring a QoS value (signaling priority) for a corresponding duplicated SBI message. Even signaling has priorities for a specific network and a specific NF. The content considers these priorities to ensure QoS (delay/performance).

For example, when a preconfigured QoS value is not obtained in a process of transmitting and receiving a duplicated SBI message from the first NF to the second NF, the first NF may perform additional operations defined subsequently, such as receiving allocation of a better SBI channel through reporting to a specific NF 200 with respect to a corresponding SBI channel, generating an additional duplicated SBI channel, or excluding (re-selecting) the corresponding second NF.

That is, through the Per DSBIM QoS Value, it is possible to individually determine detailed states of duplicated SBI messages, and the duplicated SBI messages may be individually controlled based on the information.

### (To Target NF) DSBIM Channel

This content relates to a channel for transmission when an actual NF generates and transmits a duplicated SBI message. That is, if four duplicated SBI messages are to be transmitted, it may be considered that four DSBIM channels (or redundant SBI channels) exist.

That is, depending on the structure of various NFs, a cloud, a data center, and a network path, an address for the destination may be changed. A DSBIM channel corresponds to an SBI channel which may ultimately reach a target NF, and may be generally configured as HTTP/2 or HTTP/3 according to the SBI protocol standard.

In the present disclosure, a DSBIM channel may be typically considered as one origin SBI channel when there is one SBI message, and in the case of duplicated SBI messages (2 to N SBI messages), in addition to one origin SBI channel, N−1 additional SBI channels for duplicated SBI messages may be configured/generated in a peer-to-peer manner between NFs.

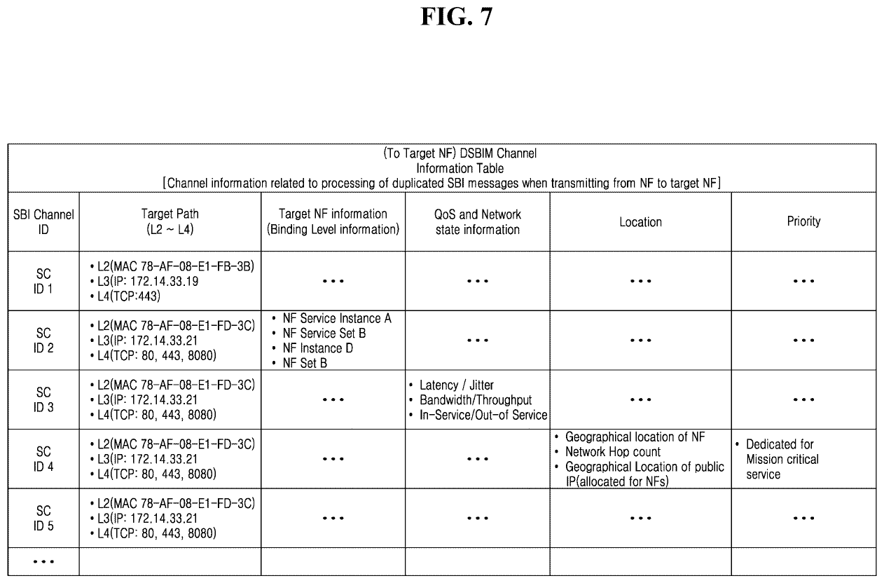

FIG. 7 is an exemplary diagram illustrating a configuration of DSBIM channel information presented in the present disclosure.

As can be seen in FIG. 7, a channel ID may be generated/assigned for each SBI channel.

That is, a channel ID for each SBI channel may be generated/assigned by combining information such as each target path, target NF information, QoS and network state information, location, and priority.

In this regard, referring again to FIG. 3, the DSBIM controller 11 may generate duplicated SBI channels to another NF (e.g., a second NF) for redundantly transmitting duplicated SBI messages (e.g., three duplicated SBI messages), according to an activated DSBIM mode (particularly the DSBIM channel of FIG. 6).

In this case, the duplicated SBI channels may be SBI channels (two channels) additionally configured in a peer-to-peer manner between an NF device 10 (e.g., a first NF) and another NF (e.g., the second NF) in order to transmit each of the duplicated SBI messages (e.g., two messages) in addition to one origin SBI message.

Subsequently, the DSBIM controller 11 may duplicate an origin SBI message to be transmitted to the other NF (e.g., the second NF) to generate N (e.g., 3) duplicated SBI messages, and transmit each of the N duplicated SBI messages to the other NF (e.g., the second NF) through DSBIM channels (e.g., one origin SBI channel/two duplicated SBI channels).

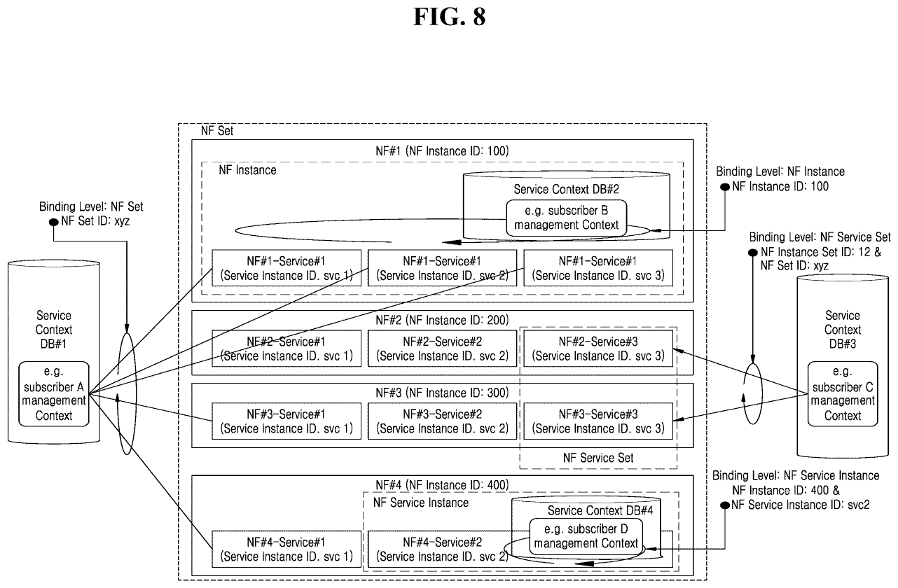

Additionally, FIG. 8 is an exemplary diagram illustrating a binding level of an NF to which the present disclosure is applied.

An NF provides a binding level for a resource in the unit of an NF service instance, an NF service set, an NF instance, and an NF set, and provides binding information when processing resource-related messages.

The example in FIG. 8 is an example of a binding level with respect to a resource context used by an NF during call processing.

According to the example of FIG. 8, a “subscriber A management context” can be managed by all NF instances included in a corresponding NF set according to a binding level in the unit of a NF set, and a service for the related call can be provided in all the NF instances included in the NF set.

Meanwhile, a “subscriber B management context” can be managed by a corresponding NF instance according to a binding level in the unit of an NF instance, and a service for the related call can be provided only within the NF instance.

Meanwhile, a “subscriber C management context” can be managed by all NF service instances included in a corresponding NF service set according to a binding level in the unit of an NF service set, and a service for the related call can be provided in the NF service instances.

Meanwhile, a “subscriber D management context” can be managed in an NF service instance according to a binding level in the unit of an NF service instance, and a service for the related call can be provided only within the NF service instance.

As described above and hereinafter, the present disclosure relates to a network function (NF), and specifically, the NFs mentioned in the present disclosure may be classified into an NF service instance, an NF service set, an NF instance, and an NF set.

That is, the scope of application of NF-to-NF communication to which a DSBIM operation of the present disclosure may be applied may include communication between an NF service instance and an NF service instance and communication between an NF set and an NF set, depending on the binding level.

However, the present disclosure is not limited to a specific binding level, and addresses a method for transmitting a duplicated SBI message during communication between NFs, and thus the method may be comprehensively applied according to a binding level configuration.

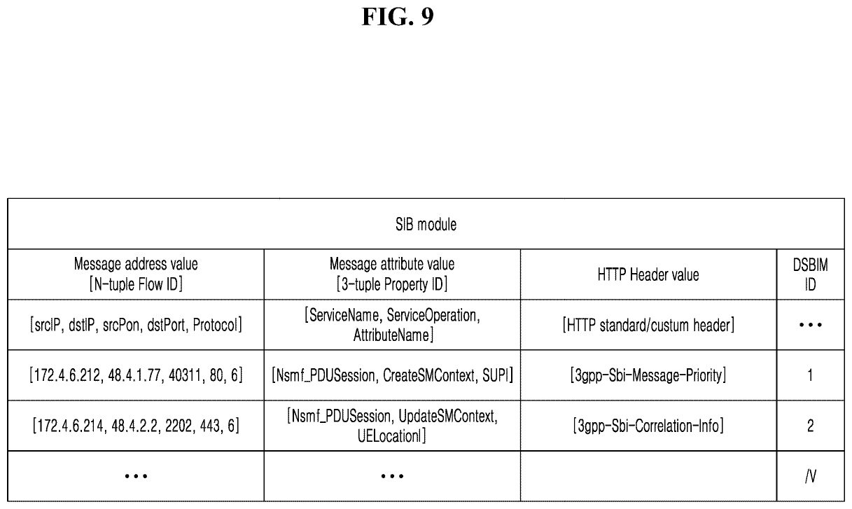

In addition, FIG. 9 is an exemplary diagram defining an SBI message value managed by an NF (internal SBI module) to which the present disclosure is applied.

As can be seen in FIG. 9, message address and message attribute values are matched for each process (e.g., the unit of a process ID) performed by an NF (internal SBI module), and furthermore, a DSBIM ID of the present disclosure is also matched.

That is, an SBI module has a structure in which, when an SBI message, i.e., a data packet, is input, the relevant content is extracted to be allocated to and processed in a resource mapped to each process (process ID).

For reference, a message address may be based on at least a 5-tuple flow ID value, and a message attribute may be based on at least a 3-tuple property ID value. For reference, a tuple may include a wildcard *. In addition, such an N-tuple-based ID may be managed as one integrated ID through basic hashing.

As described above, according to the present disclosure, by implementing a DSBIM operation which enables processing through multiple interfaces during communication between NFs (e.g., a first and a second NF) in a manner of duplicating an SBI message and redundantly transmitting the duplicated SBI message, NF-to-NF session duplication, in which an SBI message is redundantly transmitted and received between NFs in an operation of safely handling call processing (UE registration and session establishment) coming from a UE/base station, is realized.

Meanwhile, an NF range to which the DSBIM operation of the present disclosure is applied is not limited to a core NF.

As described above, the above-described embodiments of the present disclosure may be equally applied to a UENF (UE Func) and an RANF (base station Func), and the scope of application of the present disclosure is common to all NFs from the viewpoints of a UE, a base station, and a core. However, embodiments have been mainly described with reference to a network function (core) which may be commonly applied.

In addition, by additionally delivering a DSBIM indication in an operation between a UE (UENF) and an NAS (MM Core), the UE NF (UENF) may also determine a trigger/condition for performing a DSBIM operation.

An NF device 10 to which the present disclosure is applied may be NF-ized as a UE, that is, a UENF, as mentioned above.

When describing the NF device 10 to which the present disclosure is applied as a UE (UENF), the UENF 10 is NF-implemented to include a communication unit (hereinafter, an SBI module) configured to perform communication by using an SBI message according to a service-based interface (SBI) between NFs.

In addition, the UENF 10 (e.g., a first NF) to which the present disclosure is applied also includes a DSBIM controller 11 configured to perform a procedure for a duplication SBI message (DSBIM) operation of duplicating an origin SBI message to a target NF (e.g., a second NF) and redundantly transmitting the duplicated SBI message, together with a specific NF 200 (e.g., NRF, NWDAF, NEF, etc.).

The procedure for the DSBIM operation according to the present disclosure may include a step of reporting a state of the UE, that is, the UENF 10 (e.g., the first NF) and acquiring information on a DSBIM mode that can be activated in the UENF 10 (e.g., the first NF).

In addition, the DSBIM controller 11 may perform a DSBIM operation of duplicating an origin SBI message according to preconfigured DSBIM information and redundantly transmitting the duplicated SBI message during communication with another NF (e.g., the second NF).

Specifically, the DSBIM controller 11 in the UENF 10 (e.g., the first NF) to which the present disclosure is applied may determine activation of its DSBIM operation in response to handover of the UE, that is, the UENF 10 (e.g., the first NF), in response to entering a specific coverage, or according to UE slice information, an emergency mode, or a battery state.

Typically, when the DSBIM operation is turned on, the UE (UENF) may have a battery or performance impact, and thus a condition applied to the UE may be applied more conservatively than that applied to an RAN/core.

In addition, the UE (UENF) may notify the base station/core network of its state depending on whether the corresponding DSBIM operation is performed, and the final determination as to whether the DSBIM operation is to be performed may proceed according to a UE-triggered or network-triggered scheme.

As an example, the DSBIM controller 11 in the UENF 10 (e.g., the first NF) may report a state (e.g., load, battery, etc.) of the UE, that is, the UENF 10 (e.g., the first NF) to obtain information on a DSBIM mode that can be activated in the UENF 10 (e.g., the first NF).

Accordingly, the DSBIM controller 11 may configure the acquired information on the DSBIM mode, and according to the configured DSBIM mode, activate/perform a specified DSBIM operation upon handover, upon entering a specific coverage, or according to UE slice information, an emergency mode, or a battery state (UE-Triggered).

Meanwhile, FIG. 4 illustrates, as an example, a specific configuration of a specific NF 200 (e.g., NRF, NWDAF, NEF, etc.) which supports a procedure for a DSBIM operation according to the present disclosure.

Referring to FIG. 4, an NF device 200 according to an embodiment of the present disclosure performs a basic function as a specific NF 200 (e.g., NRF, NWDAF, NEF, etc.) (e.g., supporting interworking between NFs), and further includes a DSBIM controller 210 configured to perform a procedure for a DSBIM operation between NFs with respective NFs (e.g., UENF, RANF, AMF, SMF, UPF, etc.).

In this case, referring to FIG. 2, the procedure for the DSBIM operation in the present disclosure refers to a procedure of receiving DSBIM information of a first NF 10 and a second NF 10, so that a duplicated SBI message is redundantly transmitted according to an activated DSBIM mode between the first NF 10 and the second NF 10, based on the DSBIM information of the first NF 10 and the second NF 10.

As described in detail above, from the viewpoint of the specific NF 200 (e.g., NRF, NWDAF, NEF, etc.), referring to FIG. 2, the procedure for the DSBIM operation includes a step of receiving its DSBIM information from the first NF 10 and the second NF 10 through NF registration or NF update, and selecting a DSBIM mode activatable in each of the first NF 10 and the second NF 10 with respect to the respective delivered DSBIM information and notifying the first NF 10 and the second NF 10 of the selected mode.

That is, the DSBIM controller 210 may receive and manage the DSBIM information (e.g., detailed information such as whether a DSBIM is supported, DSBIM information, an activated DSBIM mode, etc.) of each NF 10, including the first NF 10 and the second NF 10, through NF registration or NF update.

In addition, the DSBIM controller 210 may apply a local policy to the corresponding content of the DSBIM information delivered from each NF 10, and select and notify each NF 10 of an activatable DSBIM mode, so as to configure the DSBIM mode for each NF 10.

In addition, from the viewpoint of the specific NF 200 (e.g., NRF, NWDAF, NEF, etc.), referring to FIG. 2, the procedure for the DSBIM operation includes a step of notifying the second NF 10 of information on an activatable DSBIM mode of the first NF 10, when delivering the second NF 10 as a response to an NF discovery from the first NF 10 or an NF notification to the first NF 10.

That is, when the DSBIM controller 210 delivers the second NF 10 as a producer discovered/selected in response to the NF discovery of the first NF 10 as a consumer, the DSBIM controller 210 may notify the consumer first NF 10 of information on an activatable DSBIM mode of the producer second NF 10, so that NFs (e.g., the first and second NFs), which will subsequently perform the DSBIM operation mutually, may share/commonly have DSBIM information (information on a DSBIM mode).

In addition, when delivering the second NF 10 as an NF notification according to a specific event regarding the second NF 10 to which the first NF 10 has already subscribed, the DSBIM controller 210 may notify the first NF 10 of information on an activatable DSBIM mode of the second NF 10, so that NFs (e.g., the first and second NFs), which will subsequently perform the DSBIM operation mutually, may share/commonly have the latest DSBIM information (information on the DSBIM mode).

As described above, according to the present disclosure, by implementing a DSBIM operation which enables processing through multiple interfaces during communication between NFs (e.g., the first and second NFs) in a manner of duplicating an SBI message and redundantly transmitting the duplicated SBI message, NF-to-NF session duplication, in which an SBI message is redundantly transmitted and received between NFs in an operation of safely handling call processing (UE registration and session establishment) coming from a UE/base station, is realized.

As such, in the present disclosure, by realizing a specific technical configuration which enables processing through multiple interfaces during communication between NFs, an effect of alleviating/resolving various problems which may be caused by a conventional structural constraint in which communication between NFs is processed through one interface may be achieved.

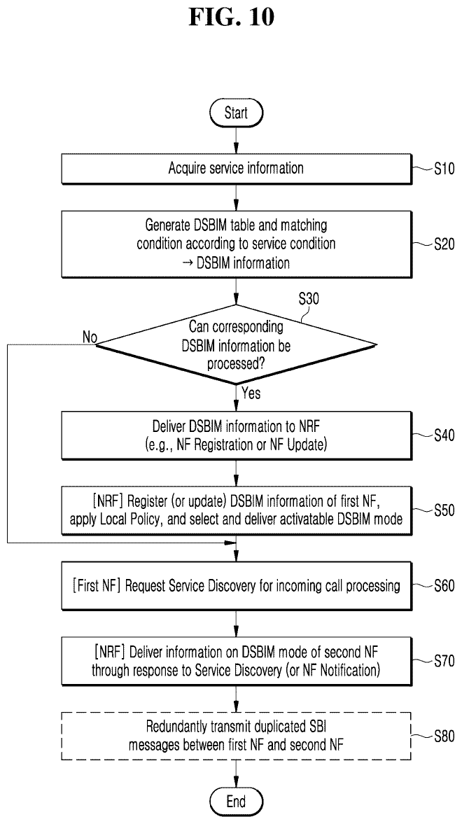

Hereinafter, FIG. 10 is a flow diagram illustrating a signaling control method performed by an NF (hereinafter, a signaling control method for a processing operation between an NF and an NRF/NWDAF) according to an embodiment of the present disclosure.

That is, according to a signaling control method for a processing operation between an NF and an NRF/NWDAF of the present disclosure, each NF 10 (e.g., UENF, RANF, AMF, SMF, UPF, etc.) may acquire subscriber service information for a service (S10), and then generate DSBIM information by generating a DSBIM table and a matching condition based on the acquired information and a service condition according to a policy from a specific NF 200 (e.g., NRF, NWDAF, NEF, etc.) (S20).

In this case, the subscriber service information may be classified into the following types.
Subscriber/UE information for each service and session information according to a service
Specific region and location-based session information
Address IDs for a UE and a base station (C-RNTI, AMF ID, E/NCGI, e/gNB ID, TAI, slice information/S-NSSAI (SST/SD))
Identifying a UE address (IP, IMSI, MSISDN, SUPI, GPSI), etc.
Signaling name and type for a UE (e.g., N1N2 message name, operation, and type)
[Service Name, Service Operation, Attribute, Data Type, . . . , value], see Table 1 below
Service capability and RAT information of a UE (frequency, RAT, base station name, etc.)
UE location (CellID, UE location information (ULI))

TABLE 1

| | | Operation | |
|---|---|---|---|
| Service Name | Service Operations | Semantics | Example Consumer(s) |
| Namf_Communication | UEContextTransfer | Request/Response | Peer AMF |
| | RegistrationCompleteNotify | Subscribe/Notify | Peer AMF |
| | N1MessageNotify | Subscribe/Notify | AMF, LMF, |
| | N1N2MessageUnSubscribe | | |
| | N1N2MessageUnSubscribe | | |
| | N1N2MessageTransfer | Request/Response | SMF, SMSF, LMF |
| | NonUeN2MessageTransfer | Request/Response | LMF, CBCF, PWS-IWF |
| | NonUeN2InfoSubscribe | Subscribe/Notify | CBCF, PWS-IWF |
| | NonUeN2InfoUnSubscribe | | |
| | N2InfoNotify | | LMF, AMF |
| | NonUenN2InfoNotify | | LMF, CBCF, PWS-IWF |
| | EBIAssignment | Request/Response | SMF |
| | AMFStatusChangeSubscribe | Subscribe/Notify | SMF, PCF, NEF, SMSF, UDM |
| | AMFStatusChangeUnSubscribe | Subscribe/Notify | SMF, PCF, NEF, SMSF, UDM |
| | AMFStatusChangeNotify | Subscribe/Notify | SMF, PCF, NEF, SMSF, UDM |
| Namf_EventExposure | Subscribe (see NOTE 1) | Subscribe/Notify | NEF, SMF, PCF, UDM |
| | Unsubscribe (see NOTE 1) | Subscribe/Notify | NEF, SMF, PCF, UDM |
| | Notify | Subscribe/Notify | NEF, SMF, PCF, UDM |
| Namf_MT | EnableUEReachability | Request/Response | SMSF |
| Namf_Location | ProviedLocation | Request/Response | GMLC |
| | EventNotify | Subscribe/Notify | GMLC |

According to a signaling control method for a processing operation between an NF and an NRF/NWDAF of the present disclosure, each NF 10 (e.g., UENF, RANF, AMF, SMF, UPF, etc.) determines whether each NF is able to process DSBIM information and a condition generated by itself (S30), and if each NF is able to process the DSBIM information and condition (S30 Yes), delivers the DSBIM information to a specific NF 200 (e.g., NRF) (S40).

Therefore, the specific NF 200 (e.g., NRF) may receive and register/manage the DSBIM information (e.g., detailed information such as whether a DSBIM is supported, DSBIM information, an activated DSBIM mode, etc.) of each NF 10 through NF registration or NF update (S50).

In addition, according to the signaling control method for the processing operation between the NF and the NRF/NWDAF of the present disclosure, the specific NF 200 (e.g., NRF) may apply a local policy to the corresponding content of the DSBIM information delivered from each NF 10, and select and notify each NF 10 of an activatable DSBIM mode, so as to configure a DSBIM mode for each NF 10 (S50).

According to the signaling control method for the processing operation between the NF and the NRF/NWDAF of the present disclosure, the NF 10 (e.g., the first NF), as a consumer, may deliver an NF discovery request to the specific NF 200 (e.g., NRF) (S60).

In this regard, when the specific NF 200 (e.g., NRF) delivers an NF 10 (e.g., the second NF) as a producer discovered/selected in response to an NF discovery of the consumer NF 10 (e.g., the first NF), the specific NF 200 may notify the consumer NF 10 (e.g., the first NF) of information on the activatable DSBIM mode of the producer NF 10 (e.g., the second NF), so that NFs (e.g., the first and second NFs), which will subsequently perform a DSBIM operation mutually, may share/commonly have DSBIM information (information on a DSBIM mode) (S70).

In addition, according to the signaling control method for the processing operation between the NF and the NRF/NWDAF of the present disclosure, when the NF 10 (e.g., the first NF) delivers the NF 10 (e.g., the second NF) as an NF notification according to a specific event regarding the NF 10 (e.g., the second NF) to which the NF 10 (e.g., the first NF) has previously subscribed, the specific NF 200 (e.g., NRF) may notify the NF (e.g., the first NF) of the information on the activatable DSBIM mode of the NF 10 (e.g., the second NF), so that the NFs (e.g., the first and second NFs), which will subsequently perform the DSBIM operation mutually, may share/commonly have the latest DSBIM information (information on the DSBIM mode) (S70).

Accordingly, according to the present disclosure, based on the activated DSBIM mode of the DSBIM information shared between the NFs (e.g., the first and second NFs), when both the first NF and the second NF are able to process the DSBIM operation (DSBIM mode) for a target message (origin SBI message) to be transmitted from the first NF to the second NF, the origin SBI message may be duplicated and transmitted as N duplicated SBI messages (S80).

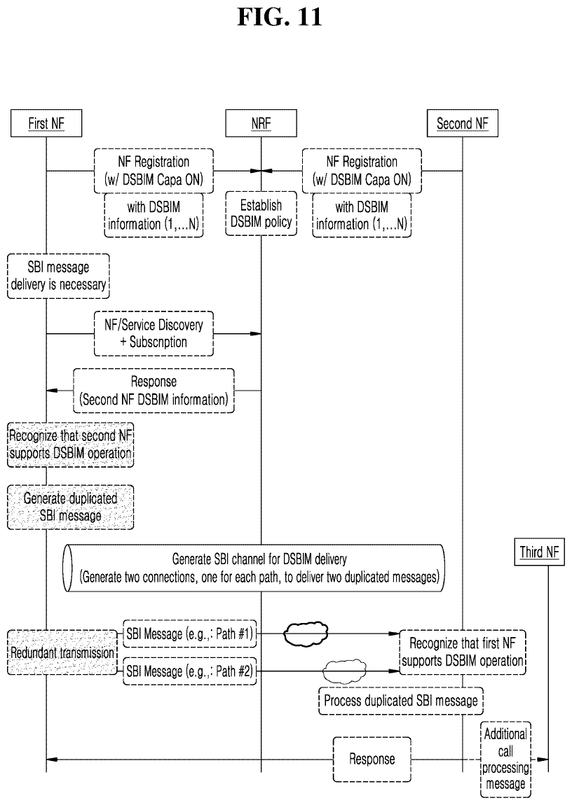

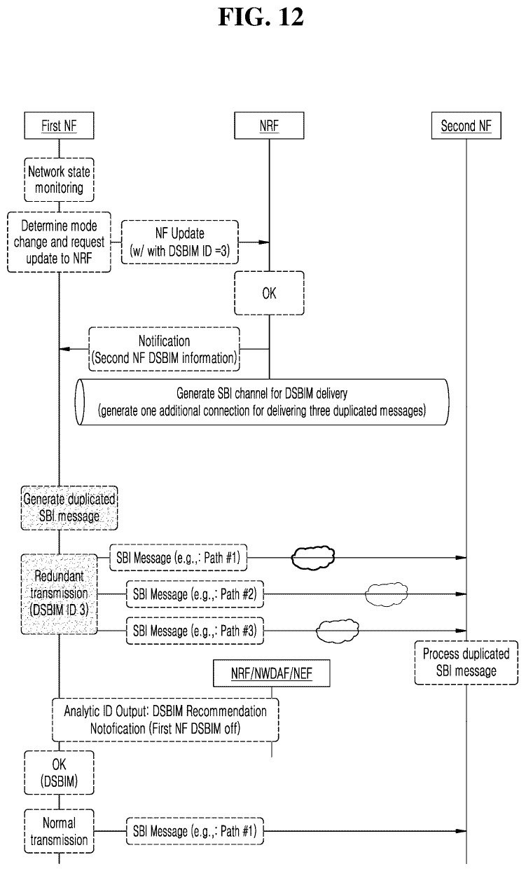

Next, FIGS. 11 and 12 illustrate embodiments of call flow proceeding according to a signaling control method performed by an NF of the present disclosure.

First, referring to FIG. 11, each NF, such as a first NF and a second NF, delivers information of each NF itself, during an NF Registration procedure for registering the information with the initial NRF 200, the information including detailed information such as whether a DSBIM is supported, DSBIM information, an activated DSBIM mode, etc.

Therefore, the NRF 200 may apply a local policy to the corresponding content of DSBIM information delivered from each NF such as the first and second NFs, establish a policy for DSBIM activation for each NF, and select and notify each NF 10 of an activatable DSBIM mode, so as to configure a DSBIM mode for each NF 10.

Thereafter, when the first NF needs to deliver an SBI message, the first NF may request NF discovery in order to obtain producer NF information as a consumer, and the NRF 200 may deliver the second NF as a producer discovered/selected in response to the NF discovery, and thus may notify the consumer first NF of information on the activatable DSBIM mode of the producer second NF, so that NFs (e.g., the first and second NFs), which will subsequently perform a DSBIM operation mutually, may share/commonly have DSBIM information (information on a DSBIM mode).

Since the first NF has recognized that the second NF supports the DSBIM operation through a response to the NF discovery, the first NF may, based on the activated DSBIM mode of the shared DSBIM information, duplicate an origin SBI message to be transmitted to the second NF to generate N (e.g., 2) duplicated SBI messages, and transmit the duplicated SBI messages to the second NF through duplicated SBI channels (e.g., path #1, #2) additionally generated for DSBIM delivery (duplicate delivery).

The second NF may determine whether the SBI messages are redundantly received, based on an SBI MSG sequence ID for each of the received duplicated SBI messages, recognize that the first NF supports the DSBIM operation, based on the activated DSBIM mode of the shared DSBIM information, process the duplicated SBI messages (e.g., N messages→1 origin message), and deliver an additional necessary subsequent call-processing SBI message.

In addition, the second NF may process the duplicated SBI messages (e.g., N messages→1 origin message), and may also deliver information on its own DSBIM mode to the first NF through a response thereto.

Referring to FIG. 12, the first NF may monitor/recognize a network state and establish a condition for performing session duplication (=DSBIM operation) of the present disclosure, according to a real-time network state.

For example, according to a condition for performing session duplication (=DSBIM operation), when the first NF determines that a change in the DSBIM mode is necessary as a result of monitoring/recognizing the real-time network state, the first NF may request an update of its DSBIM information (information on a DSBIM mode) from a specific NF 200 (e.g., NRF) through NF update.

Therefore, the specific NF 200 (e.g., NRF) may apply a local policy to the NF update from the first NF, and change/select the DSBIM mode of the first NF to notify the first NF of the DSBIM mode, so as to change/configure the DSBIM mode for the first NF.

In this process, the specific NF 200 (e.g., NRF) may deliver information on the DSBIM mode of the second NF with which the first NF is communicating, through an NF notification to the first NF.

Therefore, the first NF may change the DSBIM mode according to its network state, but share the latest DSBIM information of the second NF, and then, based on the activated DSBIM mode of the changed/shared DSBIM information, duplicate an origin SBI message to be transmitted to the second NF to generate N (e.g., 3) duplicated SBI messages, and transmit the duplicated SBI messages to the second NF through duplicated SBI channels (e.g., Path #1, #2, #3) additionally generated for DSBIM delivery (duplicated delivery).

Meanwhile, in the present disclosure, the DSBIM information (information on the DSBIM mode) of each NF may be changed/configured by the specific NF 200 (e.g., NRF).

For example, as can be seen in FIG. 12, the specific NF 200 (e.g., NRF, NWDAF, NER, etc.) may change/configure the DSBIM information (information on the DSBIM mode) of each NF, according to a DSBIM information configuration policy which considers a local policy and a real-time network state with respect to the corresponding content of the DSBIM information delivered from each NF.

Therefore, as shown in FIG. 12, the specific NF 200 (e.g., NRF, NWDAF, NER, etc.) may deliver an Analytics ID Output: DSBIM Recommendation Notification (first NF DSBIM off) to the first NF, so as to change the DSBIM operation of the first NF from On to Off.

In this case, the first NF may operate in a conventional normal delivery of an origin SBI message to be transmitted to the second NF through an origin SBI channel (e.g., path #1).

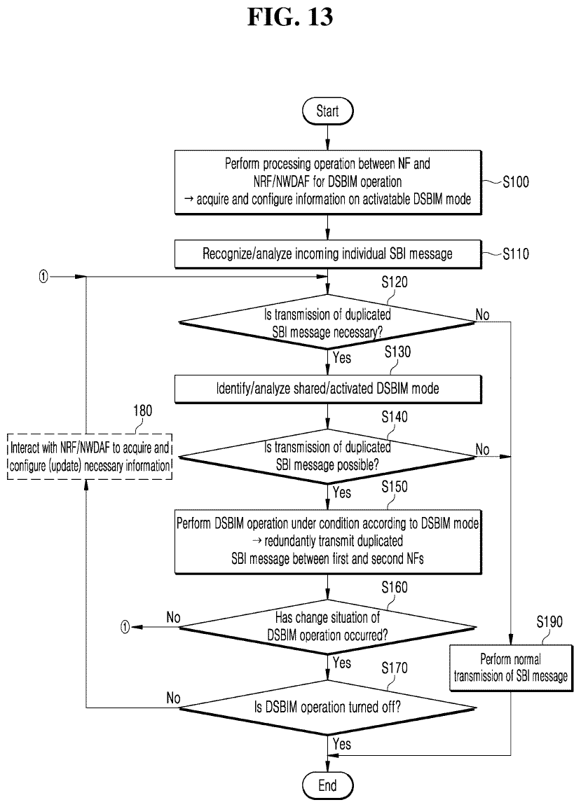

Hereinafter, FIG. 13 is a flowchart illustrating a signaling control method performed by an NF (e.g., UENF, RANF, AMF, SMF, UPF, etc.) (hereinafter, a signaling control method for a processing operation between an NF and an NF) according to an embodiment of the present disclosure.

That is, according to a signaling control method for a processing operation between NFs of the present disclosure, an NF 10 (e.g., a first NF) may acquire information on an activatable DSBIM mode, through the procedure for the DSBIM operation described above with reference to FIG. 10 (a processing operation between an NF and an NRF/NWDAF), so as to configure or change the DSBIM mode (S100).

According to the signaling control method for the processing operation between the NFs of the present disclosure, the NF 10 (e.g., the first NF) may identify/analyze an incoming individual SBI message (S110) to determine whether a corresponding session is a session requiring a DSBIM operation of transmitting a duplicated SBI message (S120).

The condition for recognizing/analyzing the SBI message may consider the following factors.
Address IDs for a UE and a base station (C-RNTI, AMF ID, E/NCGI, e/gNB ID, TAI, slice information/S-NSSAI (SST/SD))
Identifying a UE address (IP, IMSI, MSISDN, SUPI, GPSI), etc.
Signaling name and type for a UE (e.g., N1N2 message name, operation, and type)
Service capability and RAT information of a UE (frequency, RAT, base station name, etc.)
UE location (CellID, UE location information (ULI))

Therefore, according to the signaling control method for the processing operation between the NFs of the present disclosure, when the NF 10 (e.g., the first NF) determines that the corresponding session is the session requiring the DSBIM operation (S120 Yes), the NF 10 may identify/analyze a shared/activated DSBIM mode for the corresponding session (S130).

In addition, according to the signaling control method for the processing operation between the NFs of the present disclosure, the NF 10 (e.g., the first NF) may determine whether a DSBIM operation of transmitting a duplicated SBI message is possible for the corresponding session (S140).

Specifically, the NF 10 (e.g., the first NF) may determine that the DSBIM operation is possible, when both the NF 10 (e.g., the first NF) and another NF (e.g., a second NF) are able to process the DSBIM operation (DSBIM mode) for a target message (origin SBI message) to be transmitted to the other NF (e.g., the second NF), based on the shared/activated DSBIM mode of DSBIM information for the corresponding session.

Furthermore, the NF 10 (e.g., the first NF) may determine whether the DSBIM operation is possible by additionally considering the following factors.
Processing and resource load for session duplication (CPU, memory, storage), load ratio, etc.
Based on delay and jitter during session duplication
Threshold for session duplication (maximum/minimum number of sessions, etc.)

According to the signaling control method for the processing operation between the NFs of the present disclosure, when the NF 10 (e.g., the first NF) determines that the DSBIM operation is possible for the corresponding session (S140 Yes), the NF 10 may perform the DSBIM operation by duplicating an SBI message of the corresponding session under a condition according to the shared/activated DSBIM mode for the corresponding session, and then redundantly transmitting the duplicated SBI message to the other NF (e.g., the second NF) (S150).

Meanwhile, according to the signaling control method for the processing operation between the NFs of the present disclosure, when the NF 10 (e.g., the first NF) determines that the corresponding session is a session which does not require the DSBIM operation (S120 No) or determines that the DSBIM operation is not possible (S140 No), the NF 10 may perform normal transmission of only one origin SBI message to the other NF (e.g., the second NF) (S190).

Furthermore, according to the signaling control method for the processing operation between the NFs of the present disclosure, when a change situation regarding the DSBIM operation being performed occurs, based on its own determination or by the specific NF 200 (e.g., NRF, NWDAF, NEF, etc.) (S160 Yes), the NF 10 (e.g., the first NF) may change the DSBIM operation accordingly (e.g., turn on/off the DSBIM operation, change the DSBIM mode, etc.).

Specifically, in the present disclosure, a change situation regarding the DSBIM operation may occur, according to at least one of information on a DSBIM mode delivered from the specific NF 200 (e.g., NRF, NWDAF, NEF, etc.), a state of the NF device 10 (e.g., the first NF) itself, a state of the communicating other NF 10 (e.g., the second NF), a network state, and an interface state.

Therefore, according to the signaling control method for the processing operation between the NFs of the present disclosure, when a change situation regarding the DSBIM operation being performed occurs (S160 Yes), the NF 10 (e.g., the first NF) may change the DSBIM operation accordingly (e.g., turn on/off the DSBIM operation, change the DSBIM mode, etc.).

For example, as shown in FIG. 13, according to the signaling control method for the processing operation between the NFs of the present disclosure, when a change situation regarding the DSBIM operation corresponds to the DSBIM operation being turned off (S170 Yes), the NF 10 (e.g., first NF) may turn off the DSBIM operation for the corresponding session, thereby performing normal transmission of only one origin SBI message to the other NF (e.g., the second NF) for the corresponding session thereafter (S190).

In addition, according to the signaling control method for the processing operation between the NFs of the present disclosure, when the change situation regarding the DSBIM operation does not correspond to turning the operation off but a DSBIM mode change (S170 No), the NF 10 (e.g., the first NF) may change the DSBIM mode for the corresponding session by interacting with the specific NF 200 (e.g., NRF, NWDAF, NER, etc.) through a process such as an update request or acquisition of necessary information (S180).

Accordingly, according to the signaling control method for the processing operation between the NFs of the present disclosure, the NF 10 (e.g., the first NF) may perform the DSBIM operation through identification/analysis (step S130) of the (changed) DSBIM mode for the SBI message of the corresponding session identified/analyzed in step S110.

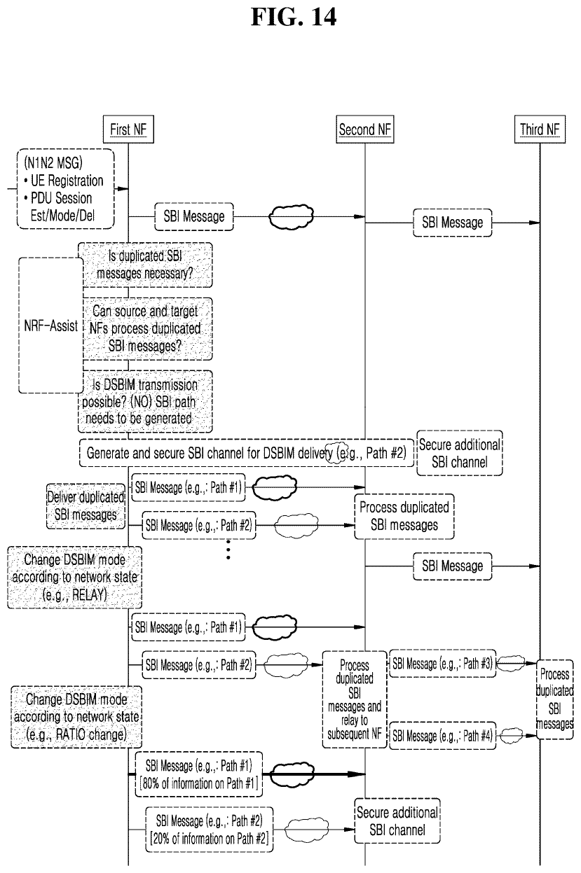

Next, FIG. 14 illustrates embodiments of call flow proceeding according to a signaling control method performed by an NF of the present disclosure.

Referring to FIG. 14, each NF such as a first NE, a second NE, and a third NF has already obtained and preconfigured DSBIM information (information on a DSBIM mode) required for a DSBIM operation, as described with reference to FIG. 11.

Continuing the description with reference to the first NF, the first NF may recognize/analyze an incoming individual SBI message, and determine whether an SBI message of a corresponding session needs to be transmitted as a duplicated SBI message (corresponding to S120 in FIG. 13).

If it is determined that the SBI message needs to be transmitted as a duplicated SBI message (Yes), the first NF may determine, with respect to the second NF as a target NF to which the SBI message of the corresponding session is to be delivered, whether both the first NF as a source NF and the second NF as the target NF are able to transmit the duplicated SBI message for the corresponding session, in consideration of the shared/acquired DSBIM information (information on the DSBIM mode) (corresponding to S140 in FIG. 13).

If it is determined that transmission of duplicated SBI messages is possible for the corresponding session (Yes), the first NF may identify whether transmission is possible under a condition (e.g., 2 duplicated SBI messages) according to a DSBIM mode shared/activated between the first NF and the second NF, and, if not possible (No), may generate and additionally secure a duplicated SBI channel (e.g., Path #2) required for the corresponding condition (e.g., 2 duplicated SBI messages).

Thereafter, according to a DSBIM mode of DSBIM information shared/activated between the first NF and the second NF, the first NF may perform a DSBIM operation of duplicating an origin SBI message to be transmitted to the second NF to generate N (e.g., 2) duplicated SBI messages, and transmitting the messages to the second NF through duplicated SBI channels (e.g., path #1, #2) for DSBIM delivery.

The second NF may determine whether the SBI messages are redundantly received, based on an SBI MSG sequence ID for each of the received duplicated SBI messages, recognize that the first NF supports the DSBIM operation, based on the activated DSBIM mode of the shared DSBIM information, process the duplicated SBI messages (e.g., N messages→1 origin message), and deliver an additional necessary subsequent call-processing SBI message to the third NF.

In the present disclosure, with respect to the DSBIM operation being performed, the first NF may change (e.g., turn on/off the DSBIM operation, change the DSBIM mode, etc.) the DSBIM operation according to a network state (network condition).

For example, as shown in FIG. 14, the first NF may change the DSBIM mode (e.g., duplication period 1-hop→2-hop) with respect to the DSBIM operation being performed, so that the transmission of duplicated SBI messages is relayed.

Accordingly, according to the changed DSBIM mode of the DSBIM information shared/activated between the first NF and the second NF, the first NF may perform a DSBIM operation of duplicating an origin SBI message to be transmitted to the second NF to generate N (e.g., 2) duplicated SBI messages, and transmitting the messages to the second NF through duplicated SBI channels (e.g., path #1, #2) for DSBIM delivery.

In addition, the second NF may process the duplicated SBI messages (e.g., N messages→1 origin message) and then, in the same manner as the first NF, according to the changed DSBIM mode of the DSBIM information shared/activated between the first NF and the second NF, perform a DSBIM operation of duplicating an origin SBI message to be transmitted to the third NF to generate N (e.g., 2) duplicated SBI messages, and transmitting the messages to the third NF through duplicated SBI channels (e.g., path #3, #4) for DSBIM delivery.

The third NF may determine whether the SBI messages are redundantly received, based on an SBI MSG sequence ID for each of the received duplicated SBI messages, recognize that the second NF supports the DSBIM operation, based on the activated DSBIM mode of the shared DSBIM information, and process the duplicated SBI messages (e.g., N messages→1 origin message).

For another example, as shown in FIG. 14, the first NF may change (e.g., a duplication ratio) the DSBIM mode with respect to the DSBIM operation being performed.

Accordingly, according to the changed DSBIM mode of the DSBIM information shared/activated between the first NF and the second NF, the first NF may perform a DSBIM operation of duplicating an origin SBI message to be transmitted to the second NF into N (e.g., two) duplicated SBI messages, generating the SBI messages such that 80% of the information is included in the SBI message to be delivered through path #1 and 20% of the information is included in the SBI message to be delivered through path #2, and transmitting the SBI messages to the second NF through duplicated SBI channels (e.g., Path #1, #2) for DSBIM delivery.

The second NF may determine whether the SBI messages are redundantly received, based on an SBI MSG sequence ID for each of the received duplicated SBI messages, recognize that the first NF supports the DSBIM operation, based on the activated DSBIM mode of the shared DSBIM information, and process the duplicated SBI messages (e.g., N messages→1 origin message).

As described above, according to a signaling control method performed by an NF of the present disclosure, by implementing a DSBIM operation which enables processing through multiple interfaces during communication between NFs (e.g., a first and a second NF) in a manner of duplicating an SBI message and redundantly transmitting the duplicated SBI message, NF-to-NF session duplication, in which an SBI message is redundantly transmitted and received between NFs in an operation of safely handling call processing (UE registration and session establishment) coming from a UE/base station, is realized.

As such, in the present disclosure, by realizing a specific technical configuration which enables processing through multiple interfaces during communication between NFs, an effect of alleviating/resolving various problems which may be caused by a conventional structural constraint in which communication between NFs is processed through one interface may be achieved.

A signaling control method according to an embodiment of the present disclosure may be implemented in the form of program instructions executable through various computer means, and may be recorded on a computer-readable medium. The computer-readable medium may include, either alone or in combination, a program instruction, a data file, a data structure, and the like. The program instructions recorded on the medium may be specially designed and configured for the present disclosure, or may be those that are known and usable by those skilled in the computer software art. Examples of the computer-readable recording medium include a magnetic medium such as a hard disk, a floppy disk, and a magnetic tape, an optical recording medium such as a CD-ROM or a DVD, a magneto-optical medium such as a floptical disk, and a hardware device specifically configured to store and perform the program instructions, such as a ROM, a RAM, or a flash memory. Examples of the program instructions include not only machine code produced by a compiler, but also high-level language code which may be executed by a computer by using an interpreter or the like. The hardware device described above may be configured to operate as one or more software modules to perform an operation of the present disclosure, and vice versa.

Although the present disclosure has been described in detail with reference to various embodiments, the present disclosure is not limited to the embodiments described above. The technical idea of the present disclosure will extend to all changes or modifications that may be made by those skilled in the art to which the present disclosure belongs, without departing from the subject matter of the present disclosure as claimed in the following claims.

1. A network function (NF) device comprising
a duplication service-based interface (SBI) message (DSBIM) controller configured to perform a DSBIM operation according to preconfigured DSBIM information during communication between the NF device and another NF,
wherein the DSBIM operation is an operation of duplicating an origin SBI message from the NF device to said another NF and redundantly transmitting the duplicated SBI message.

2. The NF device of claim 1, wherein the DSBIM controller is configured to, while redundantly transmitting the duplicated SBI message, change the DSBIM operation according to at least one of information on a DSBIM mode delivered from a specific external NF, a state of the NF device, a state of said another NF, a network state, and an interface state.

3. The NF device of claim 1, wherein the DSBIM controller is configured to, when transmitting an SBI message to said another NF, determine whether to redundantly transmit the duplicated SBI message, according to a DSBIM mode of DSBIM information activated in said another NF, and transmit the duplicated SBI message.

4. The NF device of claim 1, wherein the DSBIM controller is configured to:
during the communication between the NF device and said another NF, recognize an individual SBI message for a redundant SBI message; and
perform the DSBIM operation by processing the recognized SBI message under a condition according to an activated DSBIM mode of DSBIM information shared between the NF device and said another NF.

5. The NF device of claim 1, wherein the DSBIM controller is configured to pre-perform a procedure for the DSBIM operation with a specific NF, and
wherein the procedure for the DSBIM operation comprises a process of delivering DSBIM information of the NF device to the specific NF so as to enable information on an activated DSBIM mode between the NF device and said another NF to be shared based on the specific NF.

6. The NF device of claim 4, wherein the DSBIM controller is configured to generate a redundant SBI channel to said another NF for redundantly transmitting the duplicated SBI message, according to the activated DSBIM mode, and
wherein the redundant SBI channel is an SBI channel additionally configured between the NF device and said another NF in a peer-to-peer manner to transmit each duplicated SBI message in addition to the origin SBI message.

7. A terminal device comprising:
a communication unit configured to perform communication by using a service-based interface (SBI) message according to an SBI between network functions (NFs); and
a duplication service-based interface (SBI) message (DSBIM) controller configured to, during communication with another NF, perform a DSBIM operation of duplicating an origin SBI message according to preconfigured DSBIM information and redundantly transmit the duplicated SBI message.

8. The terminal device of claim 7, wherein the DSBIM controller is configured to determine whether to activate the DSBIM operation in response to handover of the terminal device, in response to entering a specific coverage, or according to terminal slice information, an emergency mode, or a battery state.

9. A signaling control method performed by a network function (NF), the method comprising:
a duplication service-based interface (SBI) message (DSBIM) operation performance operation of performing a DSBIM operation according to preconfigured DSBIM information during communication between the NF and another NF,
wherein the DSBIM operation is an operation of duplicating an origin SBI message from the NF to said another NF and redundantly transmitting the duplicated SBI message.

10. A network function (NF) device comprising:
a memory comprising an instruction; and
a processor configured to execute the instruction so as to perform a duplication service-based interface (SBI) message (DSBIM) operation according to preconfigured DSBIM information during communication between the NF device and another NF,
wherein the DSBIM operation is an operation of duplicating an origin SBI message from the NF device to said another NF and redundantly transmitting the duplicated SBI message.
